(19) United States
(12) Patent Application Publication
(10) Pub. No.: US 2024/0221517 A1
(43) Pub. Date: Jul. 4, 2024

(54) DEDICATED ASSISTIVE TYPING DEVICE

(71) Applicants: Emmanuel COHEN, Jerusalem (IL); Haya-Paz COHEN, Jerusalem (IL)

(72) Inventors: Emmanuel COHEN, Jerusalem (IL); Haya-Paz COHEN, Jerusalem (IL)

(21) Appl. No.: 18/401,836

(22) Filed: Jan. 2, 2024

(30) Foreign Application Priority Data
Jan. 3, 2023 (IL) 299644

(51) Int. Cl. G09B 5/06; G06F 3/01; G06F 3/04886; G09B 21/00

(52) U.S. Cl. CPC G09B 5/06; G06F 3/016; G06F 3/04886; G09B 21/003

(57) ABSTRACT

A device for language training, comprising a) a display; and b) a processor adapted to operate the display according to a preselected difficulty level, wherein operating the display includes generating a virtual keyboard or a portion thereof, and simultaneously displaying a visual cue related to one or more word(s), wherein one or more keys of the virtual keyboard are simultaneously activatable to display alphabet letters and/or digits, and wherein at least one of said keys is activatable to display a letter related to the visual cue.

### CROSS-REFERENCE TO A RELATED APPLICATION

This application claims the benefit of priority of Israeli Patent Application No. 299644, filed Jan. 3, 2023, which is incorporated by reference as if fully set forth herein.

### TECHNICAL FIELD

The present invention relates to input devices. More specifically, to a typing device tailored for diverse user groups, including individuals with disabilities, young children unfamiliar with reading and writing, and others challenged by conventional keyboard designs.

### BACKGROUND OF THE INVENTION

Traditional keyboards, while ubiquitous and universally designed, often present challenges to various user groups. Individuals with motor challenges, children in early education phases, and those unfamiliar with standard lettering, including people with developmental disabilities like autism, often find it difficult to communicate and learn using conventional input devices.

For example, many individuals with disabilities face significant challenges in learning to type. This issue is particularly pronounced for children and adults with disabilities who rely heavily on typing for communication but cannot, or have great difficulty, doing so. Furthermore, children aged 4-6 who have not had the chance to learn reading and writing start their schooling at a disadvantage compared to their peers who had such opportunities. Additionally, some people struggle with typing because of the size of the keys, making it challenging to accurately press specific keys.

Therefore, there exists a need for an inclusive, adaptable, and user-friendly typing device to cater to these unique requirements.

### SUMMARY OF THE INVENTION

A device for language training, comprising:
a) a display; and
b) a processor adapted to operate the display according to a preselected difficulty level, wherein operating the display includes generating a virtual keyboard or a portion thereof, and simultaneously displaying a visual cue related to one or more word(s);

WHEREIN one or more keys of the virtual keyboard are simultaneously activatable to display alphabet letters and/or digits, and wherein at least one of said keys is activatable to display a letter related to the visual cue.

In one aspect, the difficulty level is increasable by increasing the number of letters and/or digits activated on the keyboard keys, which are unrelated to the words that describe the visual cue.

In one aspect, the device further comprises audio output element(s).

In one aspect, the device further comprises a logic electronic component adapted to determine:
i) when the correct letter in the sequence of letters of the word describing the visual cue has been selected by a user;
ii) which letter is the next in the sequence of letters of the word describing the visual cue to display; and
iii) when all letters in the sequence of letters of the word describing the visual cue have been correctly selected by a user.

In one aspect, the device comprises memory elements in which a plurality of visual cues are stored together with words related to them. Additionally, the device is capable of receiving such cues from external sources. These sources encompass, but are not limited to, websites (for example, YouTube) and third-party providers.

In another aspect, the invention relates to a method for language training, comprising:
a) providing a display;
b) providing a processor adapted to operate the display according to a preselected difficulty level;
c) operating the display to generate a virtual keyboard or a portion thereof, and simultaneously displaying a visual cue related to one or more word(s);

WHEREIN one or more keys of the keyboard are simultaneously activated to display alphabet letters and/or digits, and wherein at least one of said keys is activated to display a letter related to the virtual cue.

In one aspect, the method further comprising:
a. Displaying an item on the display, wherein the user views and selects an item of interest;
b. Highlighting the first or subsequent letter of the selected item's name, thereby guiding the user's focus to a specific part of the word;
c. Generating a virtual keyboard on the display, where the key corresponding to the highlighted letter is visibly marked with the letter, and other keys are presented in a blank state, displaying only their outlines without letters or digits;
d. Recording the exact location of the user's press on the virtual keyboard, thereby capturing the user's interaction with the designated key;
e. Evaluating the correctness of the user's key press, determining whether the user successfully selected the key corresponding to the highlighted letter;
f. Proceeding to the next instructional step if the correct key is pressed, which includes checking if the pressed key is the last letter in the item's name and, if so, activating the associated item, such as launching a multimedia content;
g. Implementing an adaptive response if the correct key is not pressed, wherein the device assesses the frequency of incorrect key presses and, if exceeding a predetermined threshold (n times), modifies the virtual keyboard display by enlarging several keys based on the user's error range or mis-press pattern; and
h. Prompting the user to press the enlarged key corresponding to the highlighted letter, thereby facilitating adaptive learning and improving user interaction with the device.

In yet another aspect, the device of the present invention is a dedicated assistive typing device (DATD) configured for enhancing typing experiences for users with varied needs, the device comprising:
A processing unit programmed to manage and execute software modules specifically designed for assistive typing;
A touch-sensitive display adapted to display a customizable and adaptive virtual keyboard layout, sensitive to individual user typing patterns and needs;
A calibration module for detecting user mis-press patterns and dynamically adjusting virtual key sizes and positions based on these patterns;
A user-specific adaptability module, enabled by the processing unit, to continually learn and recalibrate key sensitivity and boundaries over time based on individual user interactions and historical data;
An adaptive feedback system, managed by the processing unit, providing real-time multimodal feedback (visual, auditory, and/or haptic) based on user interaction to assist in typing accuracy and learning; and
One or more communication interfaces for wired and wireless connectivity, specifically tailored to support assistive devices and applications.

In one aspect, the touch-sensitive display is configured to display a high-resolution interface for the virtual keyboard, providing a clear and user-friendly visual interaction space.

In one aspect, the DATD further comprising an ergonomic casing designed to accommodate various hand sizes and grips, enhancing user comfort and device usability, especially for users with physical disabilities or limitations.

In one aspect, the adaptive feedback system includes a haptic feedback mechanism, providing tactile responses upon user interaction with the virtual keyboard, thereby aiding users with visual impairments or those requiring physical confirmation of key presses.

In one aspect, the DATD further comprising an integrated speaker and microphone, enabling voice-to-text functionality and auditory feedback, thereby facilitating use by users with visual impairments or fine motor skill challenges.

In one aspect, the internal memory storage is configured to store multiple user profiles, allowing different users to have personalized settings and calibration data, facilitating shared use of the device in educational or therapeutic settings.

In one aspect, the calibration module includes a touch point analysis feature that specifically identifies the most common areas around keys where mis-presses occur, allowing for precise and user-specific calibration.

In one aspect, the user-specific adaptability feature includes a user feedback loop, enabling users to actively participate in the calibration process by providing feedback on key sensitivity and positioning.

In one aspect, the communication interfaces comprises connectivity ports and modules include both wired (e.g., USB, HDMI) and wireless (e.g., Bluetooth, Wi-Fi) options, facilitating connections with a wide range of peripheral devices and networks, supporting varied user environments and requirements.

In one aspect, the DATD further comprising a power management unit, designed to optimize battery life and ensure efficient power usage, particularly beneficial for users requiring extended device operation times.

In another aspect, the present invention relates to a method for enhancing typing experiences using a dedicated assistive typing device (DATD), the method comprising:
Detecting individual user typing patterns and mis-presses via a touch-sensitive display surface of the DATD;
Dynamically adjusting virtual key sizes and positions on the display surface based on the detected typing patterns and mis-presses;
Providing real-time adaptive feedback to the user through visual, auditory, or haptic means based on the user's interaction with the virtual keyboard; and
Continuously learning and recalibrating key sensitivity and boundaries over time using user interaction data and historical data stored in the DATD.

In one aspect, the method further comprises customizing the virtual keyboard layout on the DATD's touch-sensitive display surface according to user preferences and needs.

In one aspect, detecting individual user typing patterns includes analyzing touch points and pressure sensitivity to identify common areas of mis-presses and the user's unique typing style.

In one aspect, the method further comprises the step of storing user-specific settings and calibration data in internal memory storage of the DATD, allowing for personalized and consistent typing experiences across different sessions.

In one aspect, the method including adjusting the haptic feedback mechanism of the DATD to provide tactile responses tailored to the user's interaction and feedback, enhancing the typing experience for users with sensory impairments.

In one aspect, providing real-time adaptive feedback includes utilizing an integrated speaker and microphone of the DATD for auditory feedback and voice-to-text functionality, aiding users with visual impairments or fine motor skill challenges.

In one aspect, the method further comprises the step of utilizing connectivity ports and modules of the DATD for syncing with external devices and networks, thereby expanding the device's functionality and accessibility for different user groups.

In one aspect, the step of providing adaptive feedback is customized based on user-selected preferences, enabling a personalized interaction experience that caters to the specific needs and abilities of the user.

In one aspect, the method further comprises the step of offering tutorial and learning modules through the DATD to assist users in familiarizing themselves with the device and enhancing their typing skills.

In yet another aspect, the present invention relates to a computer-implemented method for facilitating adaptive typing using a dedicated application in conjunction with a Dedicated Assistive Typing Device (DATD), the method comprising:
Executing a dedicated typing application on the DATD, wherein the application is specifically configured to adapt to and support varied user needs for assistive typing;
Analyzing user input patterns on a touch-sensitive display of the DATD, including mis-presses and typing behaviors, to identify individual user typing challenges and preferences;
Dynamically adjusting a virtual keyboard layout displayed on the DATD, including key sizes and positions, in real-time based on the analyzed user input patterns.
Providing a multimodal feedback mechanism within the application, including visual, auditory, and haptic feedback, based on user interactions with the virtual keyboard to aid in typing accuracy and learning;
Storing and retrieving user-specific profiles and calibration data within the application to offer a personalized and consistent typing experience across different sessions;
Incorporating learning modules and tutorials within the application, designed to assist users in developing typing skills and familiarizing themselves with the DATD's features;
Managing connectivity options within the application to facilitate synchronization with external devices and networks, enhancing the device's functionality and accessibility; and
Continuously updating and refining the application's adaptive algorithms based on ongoing user interaction and feedback, ensuring the application evolves to meet the changing needs and improvements of its users.

In still another aspect, the present invention relates to a typing application, including a screen including a touch-screen-keyboard, characters of keys of the touch-screen-keyboard being controllable by the application for display one or more letters on the keyboard, and to enlarge one or more keys.

### BRIEF DESCRIPTION OF THE DRAWINGS

Embodiments, features, and aspects of the invention are described herein in conjunction with the following drawings:

FIG. 1A is a flowchart illustrating a language training method using a language training device, according to an embodiment;

FIG. 1B schematically illustrates a block diagram of a Dedicated Assistive Typing Device (DATD), according to an embodiment of the invention;

FIG. 1 depicts the 1-st screen of the typing application according to one embodiment of the invention;

FIG. 2 depicts the 2-nd screen of the application of FIG. 1, challenging the user with the 1-st difficulty level;

FIG. 3 depicts the 3-rd screen of the application of FIG. 1;

FIG. 5 depicts the 8-th screen of the application of FIG. 1, challenging the user with the 2-nd difficulty level;

FIG. 6 depicts the 11-th screen of the application of FIG. 1, challenging the user with the 3-rd difficulty level;

FIG. 7 depicts the 14-th screen of the application of FIG. 1, challenging the user with the 4-th being the highest difficulty level;

FIG. 8 depicts a screen of the application of FIG. 1 for challenging the user with the 2-nd difficulty level of a second task;

FIG. 9 depicts an additional feature of the touch-screen keyboard;

FIG. 10 depicts a case utilizing the learnt error space of FIG. 9;

FIG. 11 explains the teaching of correcting the error typing of FIG. 10;

FIG. 12 is another example being similar to FIG. 9, except for including a larger error space;

FIG. 13 is similar to FIG. 10, except for the larger error space of FIG. 12;

FIG. 14 explains the teaching of correcting the error typing of FIG. 13; and

FIG. 15 explains the teaching of correcting the error typing of FIG. 14.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

In accordance with the present invention, a novel language training device is described, featuring an integrated display and a specially adapted processor. This processor is programmed to control the display based on a preselected difficulty level, which is a key aspect of the invention. A significant function of the display, under the control of the processor, is to generate a virtual keyboard or a portion thereof. Concurrently, the display presents a visual cue linked to one or more words, enhancing the learning experience. The virtual keyboard is designed to allow simultaneous activation of multiple keys, each capable of displaying alphabet letters and/or digits. Importantly, at least one of these keys can be activated to exhibit a letter correlating directly with the visual cue, facilitating associative learning.

According to an embodiment of the invention, the device's difficulty level is dynamically adjustable, allowing for an increase in complexity by augmenting the number of unrelated letters and/or digits that are activated on the keyboard, thus challenging the user beyond the immediate scope of the letters describing the visual cue. Additionally, the device can be equipped with audio output elements, enriching the learning process through auditory engagement.

According to an embodiment of the invention, a critical component of this invention is its logic electronic component, which plays a pivotal role in: (i) determining when the correct letter in the sequence describing the visual cue is selected by a user, (ii) identifying the subsequent letter in the sequence to be displayed, and (iii) acknowledging the successful selection of all letters in the sequence by the user. Moreover, the device incorporates memory elements that store a diverse array of visual cues along with corresponding words, forming a comprehensive database for language training. These cues can be stored in the device's internal memory, received from external sources, or both. External sources include, but are not limited to, websites such as YouTube and various third-party providers. This flexibility allows the device to form a comprehensive and adaptable database for language training, catering to different learning needs and content updates. Extending beyond the device, the invention also encompasses a method for language training, which involves providing a display and a processor, operating the display to generate both a virtual keyboard and display a visual cue, and activating the keyboard keys to exhibit letters and digits, with specific emphasis on those related to the visual cue. This integrated approach of the device and method offers an advanced and interactive avenue for language learning, aligning with the inventive aspects of the patent application.

According to some embodiments, the present invention is a Dedicated Assistive Typing Device (DATD) that introduces an innovative input method designed to be inclusive and adaptive. Beyond features such as touch-sensitive areas and optional voice integration, it uniquely incorporates a calibration feature that detects and adapts to user mis-press patterns, ensuring a more personalized typing experience. Furthermore, it features a virtual keyboard designed to allow simultaneous activation of multiple keys, each capable of displaying alphabet letters and/or digits. Significantly, at least one of these keys can be activated to exhibit a letter correlating directly with the visual cue, thereby facilitating associative learning. The device's difficulty level is dynamically adjustable, allowing for an increase in complexity by augmenting the number of unrelated letters and/or digits that are activated on the keyboard. This feature challenges the user beyond the immediate scope of the letters describing the visual cue. Such abilities makes the DATD a versatile tool for varied user groups, including individuals with disabilities, young children unfamiliar with reading and writing, and those who find traditional keyboard designs unaccommodating. By addressing unique typing challenges, the DATD aims to level the playing field, ensuring effective communication and learning opportunities for all. An optional ergonomic design, customizable layouts, and integrated learning system may further enhance the user experience, promoting effective communication and learning.

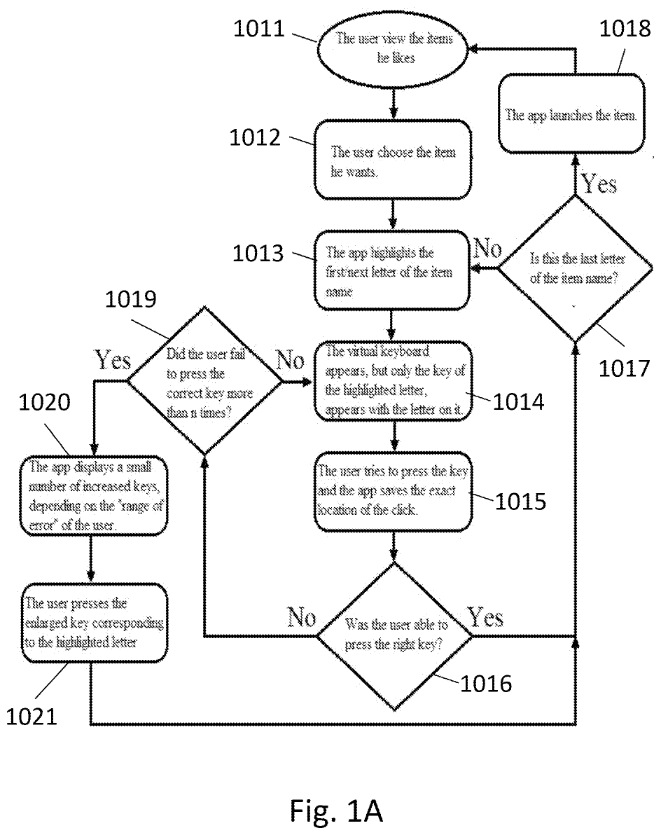

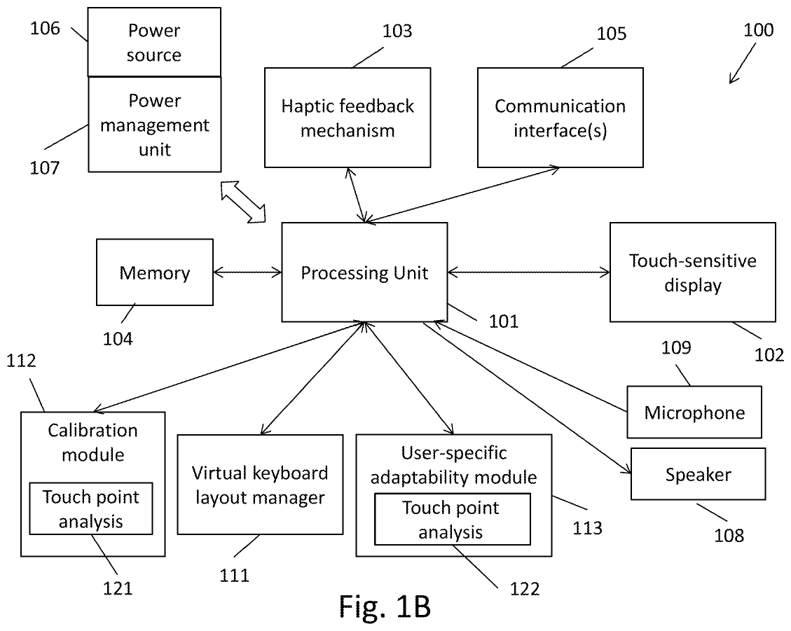

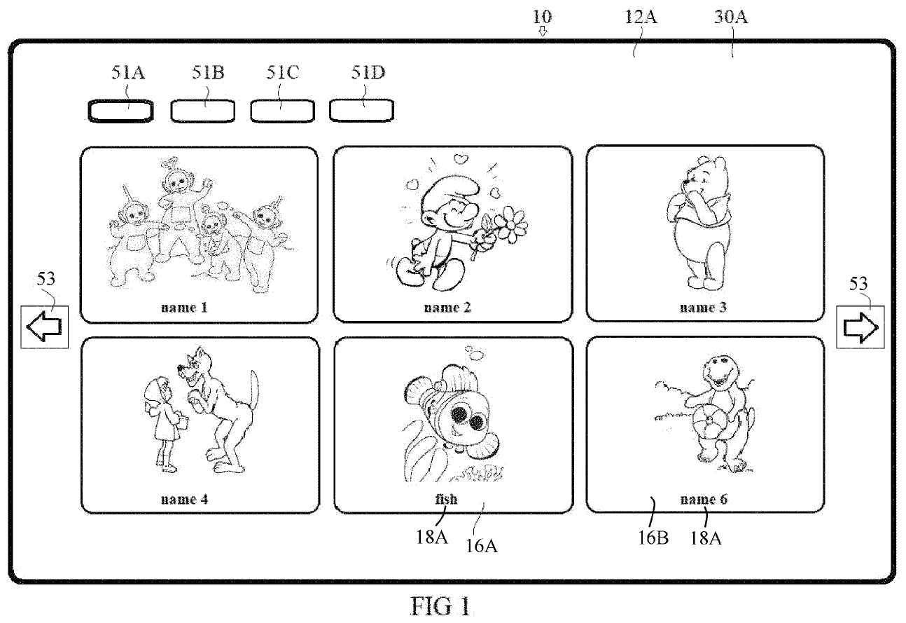

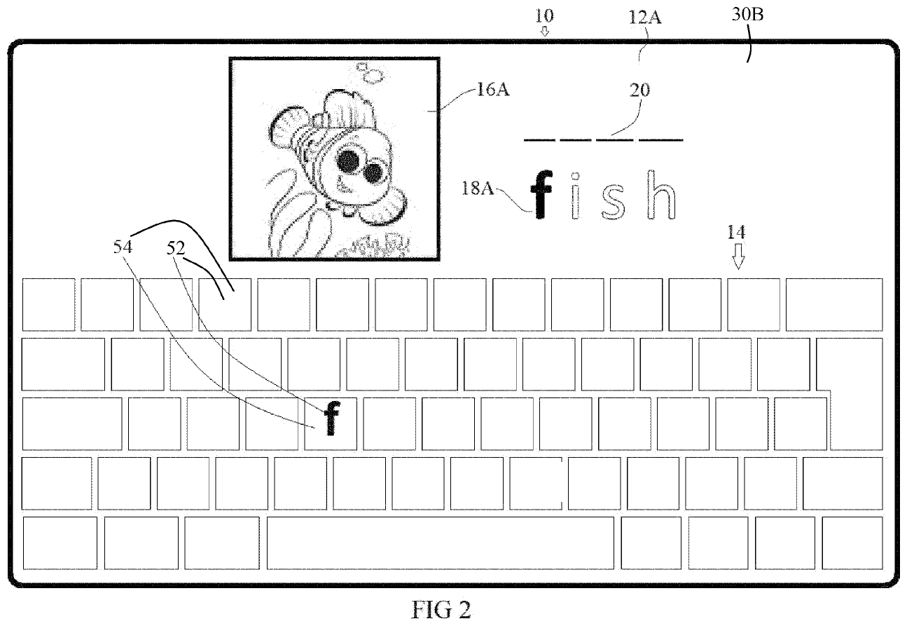

In an embodiment of the present invention, the language training method is exemplified through a flowchart, as shown in FIG. 1A, which outlines a series of steps utilizing a language training device. Initially, the user views an item of interest on the device's display (step 1011) and selects the desired item (step 1012). Following this selection, the application running on the device, such as a typing application, highlights the first or subsequent letter in the name of the selected item (step 1013). Subsequently, a virtual keyboard is displayed (step 1014), with only the key corresponding to the highlighted letter being visible and marked with the letter, while all other keys remain blank, showing merely their outlines without any letters or digits (e.g., as shown in FIG. 2, where the item is a fish, and, at this stage, only the first letter “f” appears on the virtual keyboard). The user then attempts to press the indicated key (e.g., the letter “f”), with the application recording the precise location of this action (step 1015). The next step involves the application assessing whether the user successfully pressed the correct key (step 1016), considering that the incorrect keys are blanked out. If the user successfully presses the correct key, the application checks if this letter is the last in the item's name (step 1017); if so, the application activates the item (step 1018), such as launching a video clip. If it is not the last letter, the application displays the subsequent letter (i.e., returning to step 1013). Conversely, if the user fails to press the correct key, the application determines whether this failure has occurred more than a predetermined number of times, such as ‘n’ times (step 1019). Should the user's failures be fewer than ‘n’ times, the process reverts to displaying the virtual keyboard with the highlighted letter key (step 1014). However, if failures exceed ‘n’ times, the application adapts by enlarging several keys based on the user's range of error or mis-press tendency (step 1020). The user is then prompted to press the appropriately enlarged key that corresponds to the highlighted letter, thereby facilitating learning through adaptive interaction (step 1021).

FIG. 1B schematically illustrates a block diagram of a Dedicated Assistive Typing Device (DATD) 100, according to an embodiment of the invention. DATD 100 comprises both physical components and software modules to ensure its effective operation, which includes a processing unit (PU) 101, touch sensitive display 102, haptic feedback mechanism 103, internal memory storage 104, one or more communication interfaces 105 that may include connectivity ports and modules such as wired (e.g., USB, HDMI, etc.) and wireless (e.g., Bluetooth, Wi-Fi, etc.) components for connecting to various devices, power source 106 (e.g., rechargeable battery), and an optional power management unit 107. DATD may further comprise an integrated speaker 108, a microphone 109 and an ergonomic casing.

According to an embodiment of the invention, processing unit 101 is the central component that manages and executes software modules, processes inputs, and directs operations throughout DATD 100. Touch-sensitive display 102 is high-resolution screen that virtually displays the keyboard keys and recognizes touch or gesture inputs. Haptic feedback mechanism 103 adapted to generates tactile responses upon user interaction with the display surface to confirm inputs. Speaker 108 may provide auditory feedback when virtual keys are pressed or when prompted by software module. Microphone 109 may capture voice inputs for voice-to-text functionality. Internal memory storage 104 is used for storing user profiles, settings, calibration data, and software modules. Communication interfaces 105 may comprise connectivity ports and modules both wired (e.g., USB, HDMI, etc.) and wireless (e.g., Bluetooth, Wi-Fi) components for connecting to various external devices. Power source 106 can be a battery that powers DATD 100, preferably a rechargeable variant like lithium-ion. Power management unit 107 manages power distribution, device efficiency, and charging. In some embodiments, DATD 100 may comprise ergonomic casing designed for user comfort and ease of use, tailored to various hand sizes and grips.

According to an embodiment of the invention, DATD 100 may comprise one or more of the following software modules:
Virtual Keyboard Layout Manager 111: Dictates the appearance, size, and positioning of virtual keys on the touch-sensitive display;
Calibration Module 112: Adjusts and optimizes the virtual key sizes and positions based on user typing patterns and feedback; and
User-specific adaptability module 113: This feature enabled by processing unit 101, to continually learn and recalibrate key sensitivity and boundaries over time based on individual user interactions and historical data. The user-specific adaptability module 113 ensures that every interaction with DATD 100 is a step towards a more intuitive and user-friendly typing experience, as will be described in further details hereinafter.
   DATD 100 may further comprise one or more additional modules (not shown):
Gesture Recognition: Processes and translates user gestures into relevant inputs or actions.
Voice-to-Text Engine: Converts spoken words into typed text.
Adaptive Feedback System: Provides real-time visual, auditory, or haptic feedback based on user interaction.
User Profile Manager: Stores user-specific settings, preferences, and calibration data.
Tutorial and Learning Module: Offers guidance and lessons to users for enhanced typing and device familiarity.
Connectivity Manager: Oversees the wired and wireless connections, ensuring seamless data transfer and device pairing.

Combining these physical components with the software modules ensures that DATD 100 is both versatile and user-friendly, adapting to the needs of its users and providing an enhanced typing experience.

The primary function of DATD 100 is to offer an alternative typing solution that's tailored to the needs of its user, whether they're individuals with disabilities, young children, or those who struggle with traditional keyboards. By introducing features like large keys, touch-sensitive areas, and voice integration, the device becomes a multifaceted tool. The adaptive feedback system ensures that users get immediate confirmation of their inputs, while the ergonomic design and customizable layouts prioritize comfort and ease of use. The built-in learning system offers guidance, assisting in the journey towards effective communication.

According to an embodiment of the invention, the user-specific adaptability module 113 is a crucial component of DATD 100. Enabled by processing unit 101, this feature allows DATD 100 to personalize the typing experience for each user by learning from their interactions and recalibrating key sensitivity and boundaries.

According to some embodiments of the invention, user-specific adaptability module 113 may work as follow:
1. Learning Phase: When a user types on the DATD's 100 touch-sensitive display 102, the processing unit 101 captures each keystroke's location and pressure. This includes accurately recording the center of the touch and the area covered by a finger of the user (or stylus). For users with motor skill challenges, touches might consistently be off-center or larger than the actual key size.
2. Analysis: The processing unit 101 analyzes this data to identify patterns. For instance, if a user consistently presses the edge of a key or often hits two keys at once, the device notes these tendencies.
3. Calibration Phase: Using the identified patterns, the device adjusts the virtual key sensitivity and boundaries. If a user often hits the space between the “G” and “H” keys, the DATD 100 may expand the active area of the “G” key if that is the intended target more often than “H”.

The functionality of user-specific adaptability module 113 will be better understood by the following examples of adaptability:
Size Adjustment: For a user who frequently misses the “E” key, hitting the “W” key instead, the DATD 100 could enlarge the active area of the “E” key, reducing the size of neighboring keys' sensitive areas if they are less used.
Position Adjustment: If a user regularly hits the bottom part of keys, the DATD 100 could recalibrate the keys so that the sensitive area is shifted downwards.
Sensitivity Tuning: For those who have a lighter touch and often find that their keystrokes are not registered, the DATD 100 can increase the sensitivity so that lighter touches are recognized more consistently.
Historical Data Use: By analyzing historical data from a user who has improved over time, the DATD 100 can predict and adjust to the user's evolving typing style, preempting mistakes before they happen.

The user-specific adaptability process is iterative and continuous, with DATD 100 constantly refining its understanding of the user's habits. As the user's typing behavior changes, whether through improvement or due to different physical conditions, DATD 100 adapts. It's a feedback loop that offers a bespoke typing experience that evolves with the user's needs. By tailoring the key sensitivity and boundaries, users make fewer errors, leading to faster and more accurate typing. Users with physical disabilities can type with less effort, as the keys work with their unique style, not against it. For children or users with learning disabilities, DATD 100 can gradually challenge them by slowly returning to standard key sizes and sensitivity as their accuracy improves, supporting their learning process. Each user's experience is unique, making the DATD feel like a personal tool adapted to their own way of typing.

FIG. 1 introduces the 1-st screen of a typing application 10 of DATD 100, according to one embodiment of the invention. For example, this typing application 10 optimized for children with autism, showcases several movies as selectable items (16A, 16B, etc.) on a touch screen 12A. On this first screen, labelled 30A, a user can press an item such as 51A to access these movies, then further press item 16A to select the “fish” movie.

FIG. 2 presents the second screen of typing application 10, proposing the first level of typing difficulty. Here, only the selected “fish” movie item 16A appears, accompanied by a text (18A) prompting the user to type the word “fish”. Successfully typing the word will play the movie as a reward. To assist with this typing task, a touch-screen-keyboard 14 is displayed. Interestingly, only the first letter, “f”, of the word “fish” is shown on the keyboard, guiding the user to type in sequence. A dedicated field 20 awaits user input.

At the 2-nd screen enumerated 30B, application 10 shows the selected item 16A of the “fish” movie only, and 20 further shows a text 18A given to the user for being typed by the user, being in the example “fish”. Application 10 awards the user to run the movie upon completing typing the “fish” text 18A. For addressing the typing task, the 2-nd screen of application 10 displays a touch-screen-keyboard 14 on touch screen 12A, in addition to item 16A and text 18A. The 1-st letter of “fish” text 18A is “f”, which must be typed first. At this 2-nd screen, only the “f” key of touchscreen-keyboard 14 includes its lettering whereas all the other keys are blank as not including their lettering. Thus the current character 52 of the “f” key 54 is lettered whereas the current character 52 of the other keys is blank. The blank 10 character 52 of the key provides that pressing on that key does not fill anything in field 20.

In text 18A, “f” only is accented. Application 10 further displays a typed field 20. Typed field 20 is empty prior to typing by the user.

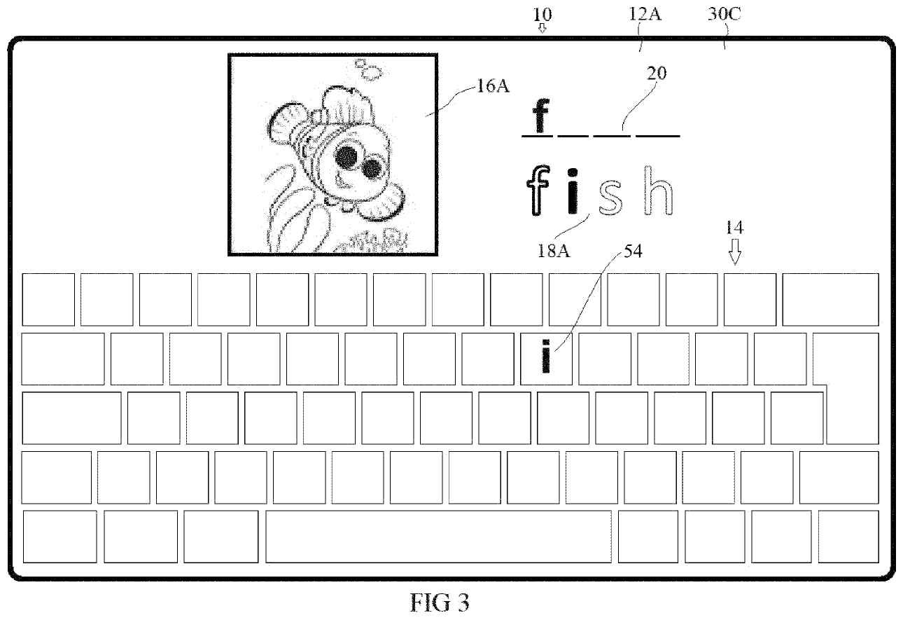

FIG. 3 depicts the 3-rd screen of the application of FIG. 1. By FIG. 3, the user has typed the letter “f”, and the next letter, “i”, is highlighted on the touch-screen keyboard 14. This sequential highlighting continues for subsequent letters “s” and “h” on the subsequent screens. Typing the entire word correctly plays the “fish” movie on the sixth screen, and the seventh screen reintroduces the movie selection from FIG. 1.

At the 3-rd screen enumerated 30C, being after the user has typed the “f” letter, application 10 displays typed field 20, which now includes the typed “f”. Item 16A of the “fish” movie, and “fish” text 18A remain. The next letter of “fish” text 18A for being typed is “i”. Thus, at this 3-rd screen, only “i” key 54 in touch-screen keyboard 14 is lettered; and in text 18A, only “i” is accented. The next letter of “fish” text 18A for being typed is “s”. Thus, at the 4-th screen, only “s” in touch-screen-keyboard 14 is lettered; and in text 18A, only “s” is accented. The next letter of “fish” text 18A for being typed is “h”. Thus, at the 5-th screen, only “h” in touch-screen-keyboard 14 is lettered; and in text 18A, only “h” is accented. Once the user has completed typing the word “fish”, the “fish” movie is run at the 6-th screen as a prize for the correct typing.

The 7-th screen may display again the items of FIG. 1. The user may press again touch screen 12A on item 16A of the “fish” movie for being run, including “fish” text 18A.

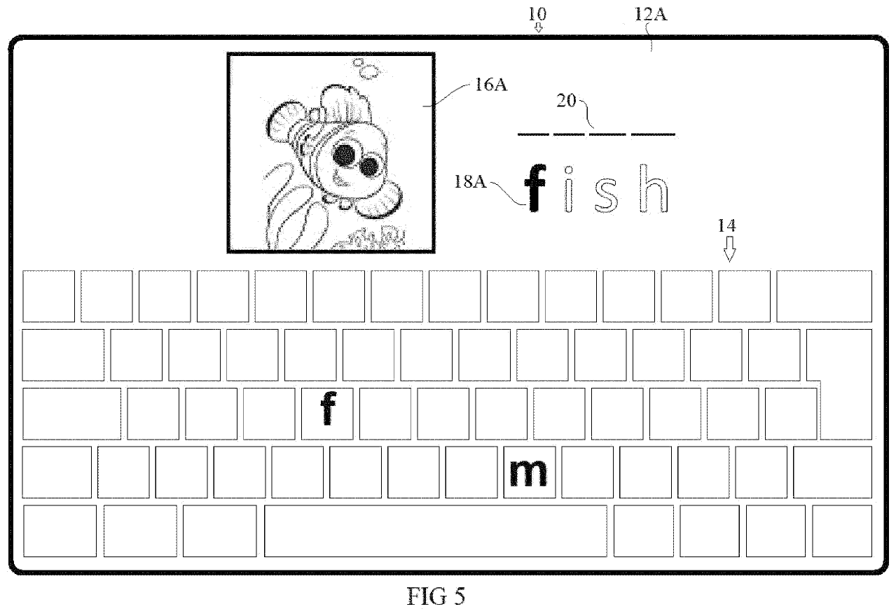

The typing application 10 of DATD 100 progressively increases its challenge. FIG. 5 introduces the second difficulty level, where the user encounters misleading letters like “m” on the keyboard alongside the correct letter. Yet, as before, typing “fish” correctly rewards the user with the movie playback.

FIG. 5 depicts the 8-th screen of the application of FIG. 1, challenging the user with the 2-nd difficulty level. At the 8-th screen, application 10 shows again item 16A of the “fish” movie only, and further shows “fish” text 18A, and promises running the movie only after typing “fish” text 18A. The 1-st letter of “fish” text 18A is “f”, which must be typed 1st. However, at the 8-th screen, being after the user has completed typing at the 1-st difficulty level, at the 2-nd difficulty level of the 8-th screen except for the correct letter “f” 20 of FIG. 2 being visible in text 18A and in touch-screen-keyboard 14, a misleading letter “m” as well is visible in touch-screen keyboard 14. Application 10 further displays a typed field 20. Typed field 20 is empty prior to typing by the user. Once the user has completed typing the word “fish” at the 2-nd difficulty level including one misleading letter in touch-screen-keyboard 14 of each screen, the “fish” movie is run at the 9-th screen as a prize for the correct typing.

The 10-th screen may display again the items of FIG. 1. The user may press again touch screen 12A on item 16A of the “fish” movie for being run, including “fish” text 18A.

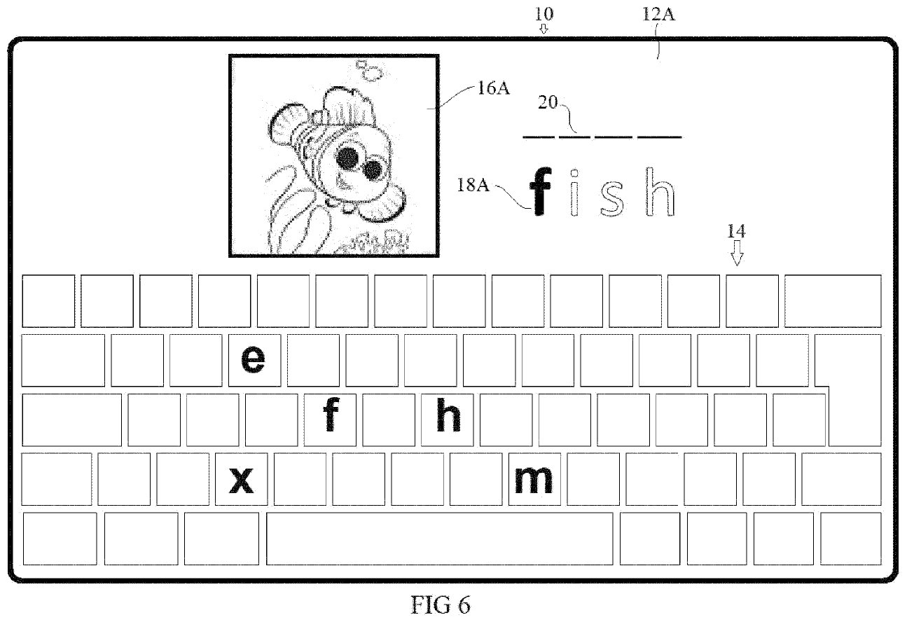

By FIG. 6, the third difficulty level presents. FIG. 6 depicts the 11-th screen of the application of FIG. 1, challenging the user with the 3-rd difficulty level. After progressing through the first two levels, the user now faces multiple misleading letters. Still, accuracy in typing “fish” results in the movie's playback.

At the 11-th screen, application 10 shows again item 16A of the “fish” movie only, and “fish” text 18A, and promises running the movie only after typing “fish” text 18A. The first letter of “fish” text 18A is “f”, which must be typed first. However, at the 11-th screen, being after the user has completed typing at the 1-st difficulty level of no misleading letters, and has completed typing at the 2-nd difficulty level of one misleading letter, at the 10-th screen except for the correct letter “f” of FIG. 2 and the misleading letter “m” of FIG. 5, additional misleading letters “e”, “h”, and “x” as well are visible in touch-screen-keyboard 14. Once the user has completed typing the word “fish” at the 3-rd difficulty level, the “fish” movie is run at the 12A-th screen as a prize for the correct typing. The 13-th screen may display again the items of FIG. 1. The user may press again item 16A of the “fish” movie for being run.

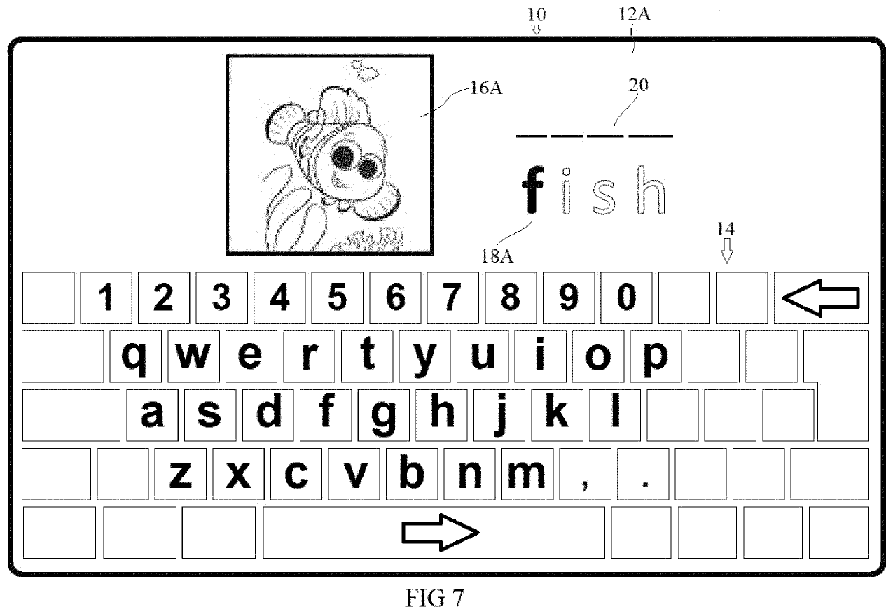

FIG. 7 represents the fourth, possibly the highest difficulty level. The user is tasked with discerning the correct letters among all others to type “fish”. Completing this rewards with the movie, similar to previous levels. FIG. 7 depicts the 14-th screen of the application of FIG. 1, challenging the user with the 4-th being the highest difficulty level.

At the 14-th screen, application 10 shows again item 16A of the “fish” movie only, and “fish” text 18A, and promises running the movie only after typing “fish” text 18A. The first letter of “fish” text 18A is “f”, which must be typed first. At the 14-th screen, being after the user has completed typing at the 1-st, 2-nd and 3-rd difficulty levels, at the 14-th 10 screen challenging the user with the 4-th difficulty level which may be the highest one, correct letter “f” of FIG. 2 and all the other letters. Once the user has completed typing the word “fish” at the 4-th difficulty level, the “fish” movie is run at the 15-th 15 screen as a prize. The screen may display again the items of FIG. 1. The user may press again item 16A of the “fish” movie for being run. Lower difficulty levels, may be added before this 4-th difficulty level, e.g., these 1-st to 4-th levels may include 26 difficulty levels.

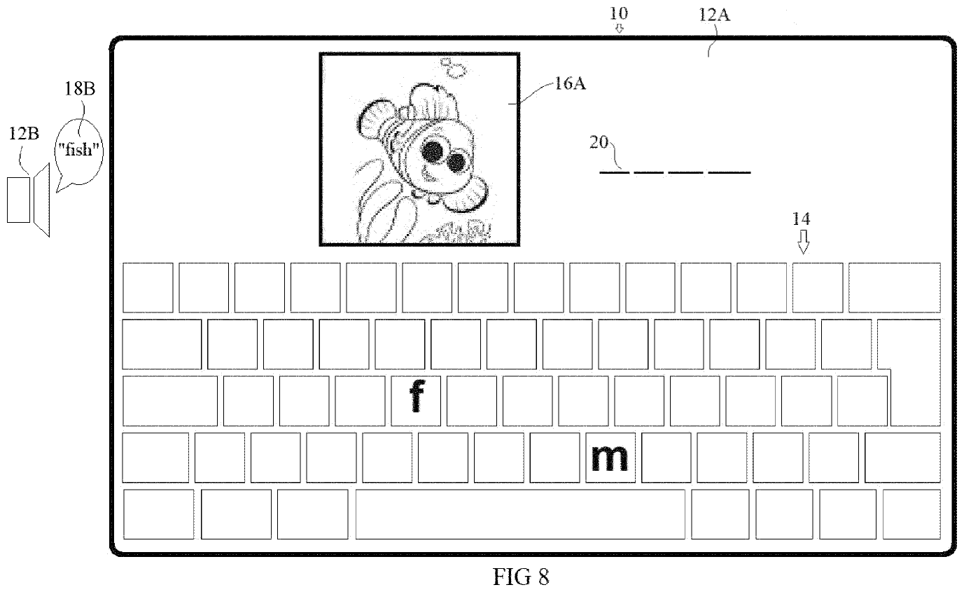

Subsequent challenges introduce nuanced learning methods. For instance, FIG. 8 details a task where users type words they hear, not see. This auditory challenge omits the visual prompt of the word “fish”, replacing it with an auditory cue via loudspeaker 12B. Typing the heard word correctly plays the movie.

FIG. 8 depicts a screen of the application of FIG. 1 for challenging the user with the 2-nd difficulty level of a second task. After completing the 26 levels of difficulty in all the letters of a certain word, the application will move to the next task where the user will be required to write the word only by hearing it, without seeing its text written. Also, in this task the user will perform all difficulty levels (1-26) in all letters. At the screen of FIG. 8, application 10 shows again item 16A of the “fish” movie only.

Typing based on hearing is much more difficult than typing based on viewing. Thus, in contrast to the 2-nd difficulty level at the first task (FIG. 5), at the same difficulty level at the 2-nd task, “fish” text 18A is not displayed on touch screen 12A. Rather, vocal “fish” 18B is sounded by a loudspeaker 12B. Once the user has completed typing the word “fish” at the 2-nd task at the 2-nd difficulty level, the “fish” movie is run at the next screen as a prize.

At the 3-rd task the user may type the name of the item he wants, without seeing the picture or drawing of the item, and without hearing the name of the item. This step is only done at the highest level when all the letters appear on the keys.

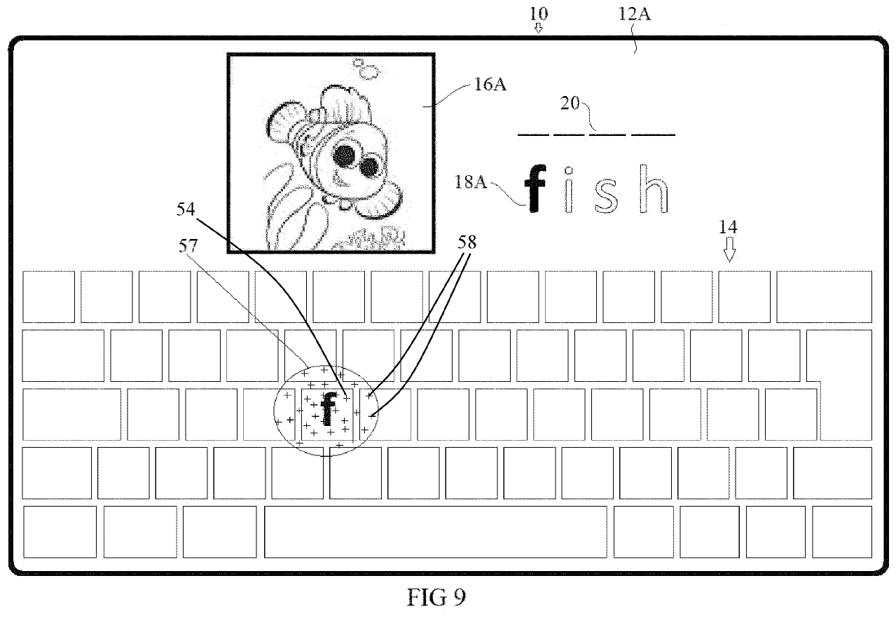

According to an embodiment of the invention, DATD 100 encompasses a unique feature known as “Adjustable Key Size”, also referred to as “Virtual Key Expansion”. Designed to cater to specific user challenges, this feature is clearly illustrated in the context of FIG. 9. When users struggle to press keys due to their inherent size, the typing application 10 of DATD 100 not only tracks these mis-presses but also initiates a calibration process by calibration module 112 (FIG. 1A). As users navigate through the first difficulty level, the application 10 logs touch points, and if a pattern emerges, such as consistent mis-presses near the “f” key, the system begins a calibration process to address this issue.

FIG. 9 depicts an additional feature of the touch-screen keyboard. In cases where the user has difficulty pressing a certain key because of its size, application 10 may repeat the first difficulty level until it collects enough “click points” to calculate the user's “space of error”. This will repeat for all letters. For example, the 2-nd screen of the application of FIG. 1 may challenge the user again and again with the 1-st difficulty level, by showing the selected item 16A of the “fish” movie only, and further shows text 18A given to the user for making the user type the letter “f” of “fish”. Application 10 may utilize touch screen 12A within this typing for recording the pressings of the user, for analyzing them.

For example, application may record that the user has pressed around (57) key 54 of the “f” letter of touch-screen keyboard 14 as sensed by pressing on points 58 and others of touch-screen-keyboard 14, which is expected to be pressed, thus missing key 54. The application that will calculate the error space 57 of the letter f for later use.

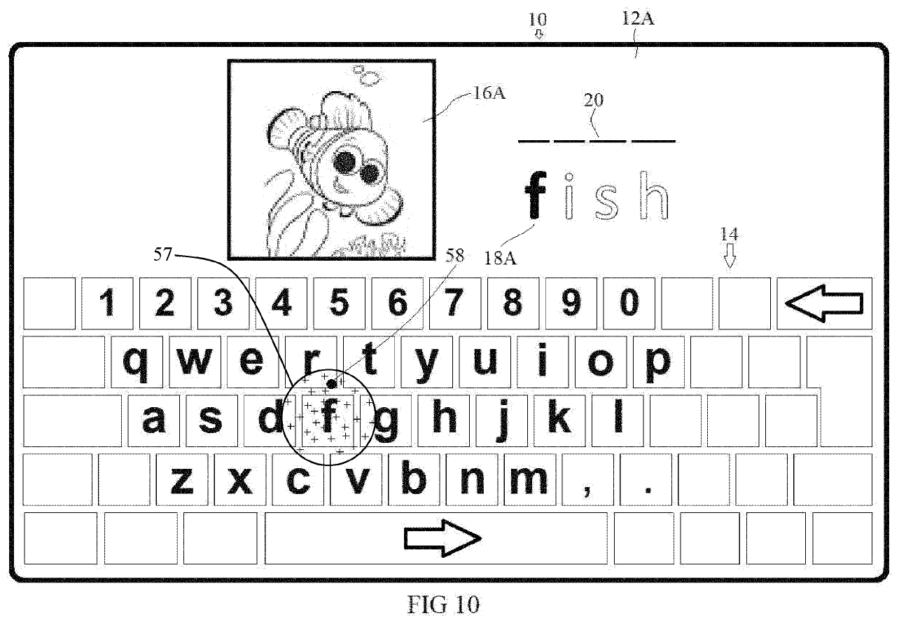

FIG. 10 depicts a case utilizing the learnt error space of FIG. 9. After application 10 has learnt error space 57, application 10 may display the letters of a higher level, such as of FIG. 7. Suppose the user has pressed point 58, being between “f” and “r” keys within error space 57, including letters “r”, “d”, “f”, and “g”.

According to an embodiment of the invention, if a user frequently mis-presses in the vicinity of a specific key (e.g., “f” key), one or more calibration techniques can be employed by DATD 100:
Touch Point Analysis 121 (FIG. 1): The application begins by analyzing the specific touch points where the user's presses are being registered. By collecting data over multiple typing sessions, it determines the most common areas around the “f” key where mis-presses occur;
Virtual Key Boundary Adjustment 122 (FIG. 1): Based on the touch point analysis 121, the application can then adjust the virtual boundary of the “f” key, expanding its active zone to the areas where mis-presses are most frequent;
Sensitivity Tuning: DATD 100 might also adjust the sensitivity of the surrounding keys. For instance, if a user often presses the space between the “f” and “g” keys, the device could reduce the sensitivity of the “g” key's left boundary while expanding that of the “f” key. For example, this sensitivity tuning feature can be part of the user-specific adaptability module 113 (FIG. 1);
User Feedback Loop: Post-calibration, as an option, DATD 100 can offer a testing phase where the user can type and provide feedback. If mis-presses persist, the device can iterate and refine the calibration further;
Historical Data Reference: DATD 100 could also leverage historical data from other users who've faced similar issues. By referencing this data, the device might anticipate problematic areas around the “f” key and preemptively calibrate for a new user.
Adaptive Learning Over Time: Rather than a one-time calibration, DATD 100 continuously learns from the user's typing patterns. As users improve or as their mis-press habits change, the device can dynamically recalibrate the virtual key boundaries to ensure optimal typing accuracy.

In identifying these trends, DATD 100 ensures that it can calibrate the virtual key boundaries effectively to cater to each user's unique needs.

Capitalizing on its data-driven adaptability, as showcased in FIG. 10, DATD 100 subsequently adjusts the keyboard layout in the later levels, expanding the virtual zones around each key. This effectively enlarges the key's active pressing area without visually altering its size, leveraging the Adjustable Key Size mechanism (e.g., via the virtual keyboard layout manager 111 of FIG. 1).

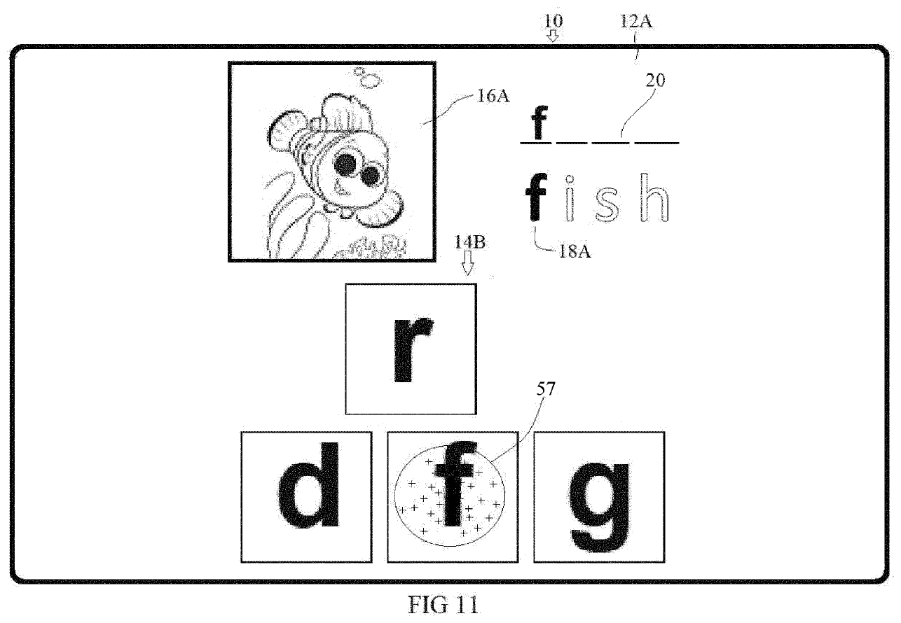

FIGS. 11-15 offer a more detailed insight into the DATD's 100 adaptability. By magnifying keys or zones that have consistent mis-presses, it provides users with clearer and more forgiving targets. But these aren't just visual enlargements; they reflect the calibration of the virtual key expansion zones. If challenges persist for a user, even after these adjustments, DATD 100 offers further calibration of the virtual zones. This ensures that the hardware-centric solutions of DATD 100 address each user's unique typing needs.

In essence, the typing application 10 of DATD 100 dynamically adjusts to users, especially beneficial for children with autism, enhancing their typing experience and ensuring continued engagement and learning.

FIG. 11 explains the teaching of correcting the error typing of FIG. 10. In the case of FIG. 10, application 10 will not yet fill field 20. Rather, application 10 will display a new screen enlarging letters “r”, “d”, “f”, and “g” which were included in the previous screen in error space 57. Thus the new touch-screen-keyboard is individually adapted to the user based on the margin of error and the click point described in FIG. 9 and FIG. 10. Error space 57 in this new keyboard includes one letter only, thus helping the user to type the desired key “f” in the example. Area 57 of the error space is smaller than the size of each key, the key the user will press is the key he intended, without the effect of his disability, and thus application 10 will fill field 20 with the letter “f”, showing the success of the user.

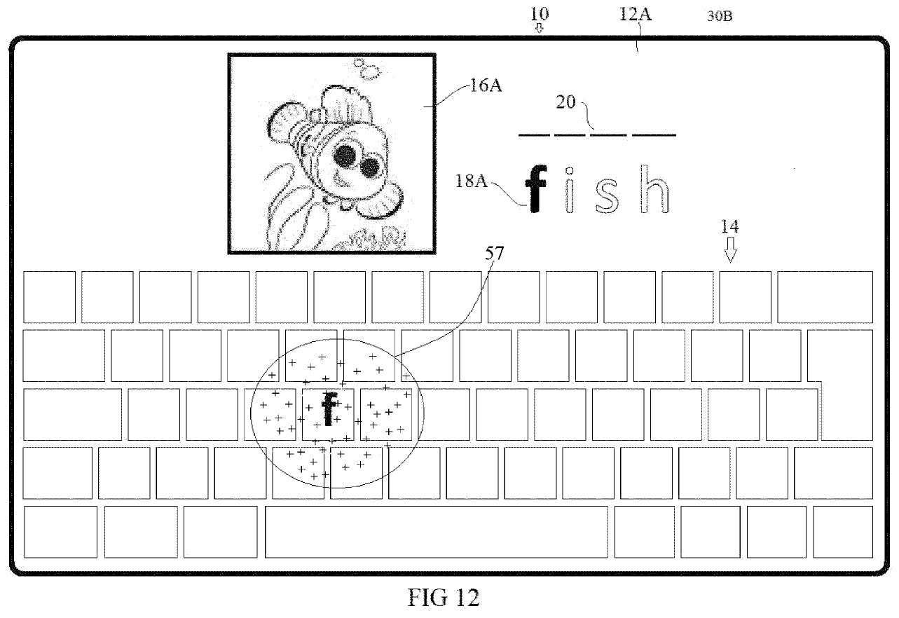

FIG. 12 is another example being similar to FIG. 9, except for including a larger error space. In the example of FIG. 12, error space 57 is larger than error space 57 of FIG. 9.

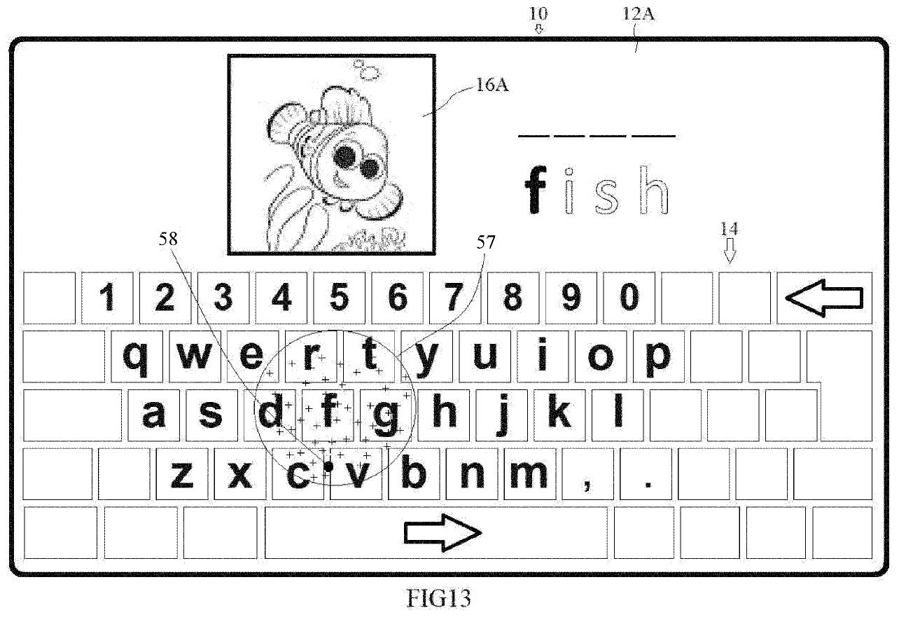

FIG. 13 is similar to FIG. 10, except for the larger error space of FIG. 12. In the example of FIG. 13, the user has pressed point 58, being between “c” and “v” keys within large error space 57, including letters r, t, d, f, g, c, v and b.

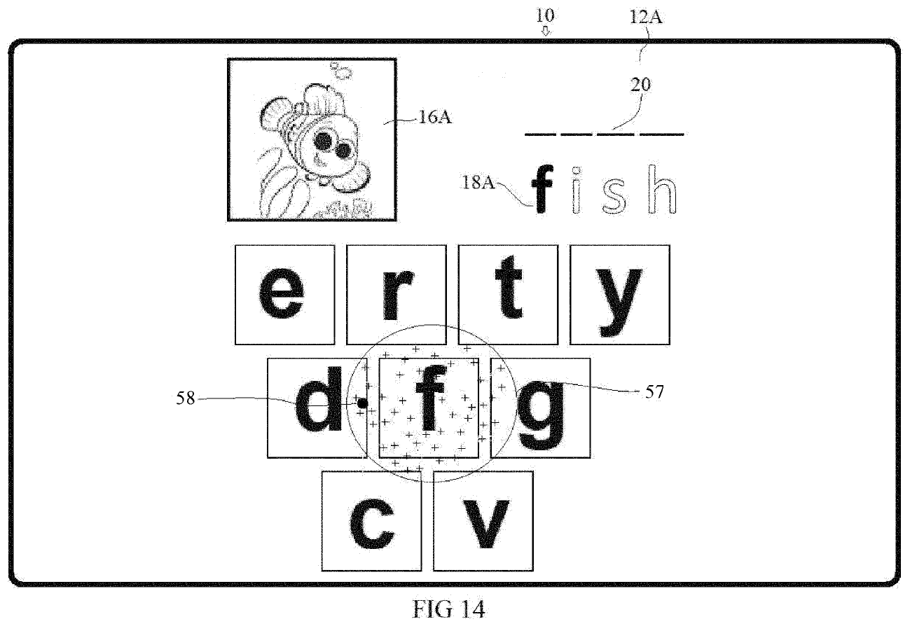

FIG. 14 explains the teaching of correcting the error typing of FIG. 13. In the case of FIG. 13, application 10 will not yet fill field 20. Rather, application 10 will display a new screen enlarging letters “r”, “t”, “d”, “f”, “g”, “c”, “v” and “b” which were included in the previous screen in error space 57. However, yet error space 57 even in the new screen includes letters “r”, “d”, “f”, and “g”. Suppose the user has pressed point 58 between letters “d” and “f”.

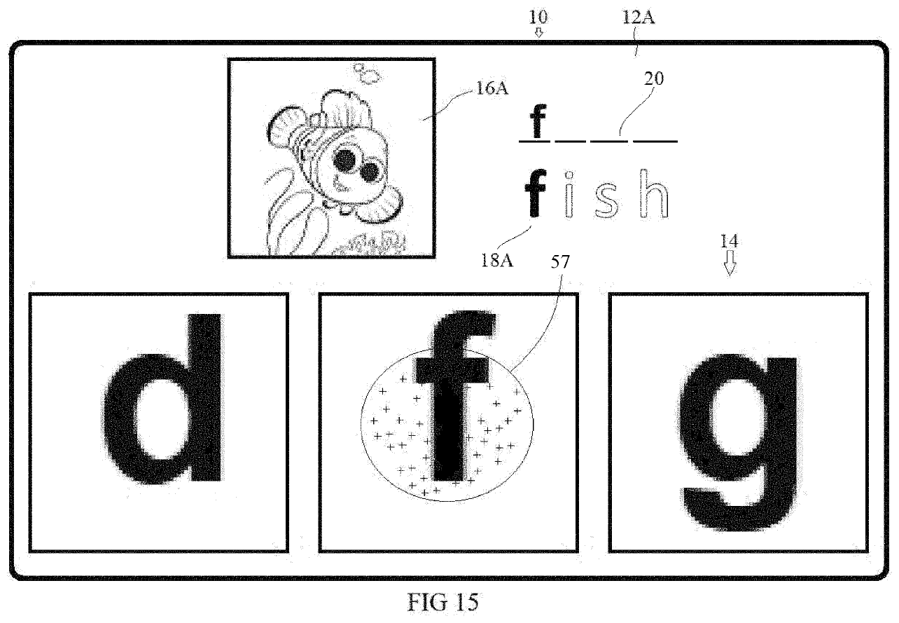

FIG. 15 explains the teaching of correcting the error typing of FIG. 14. In the case of FIG. 14, application 10 will not yet fill field 20. Rather, application 10 will display a new screen repeating the enlarging of the letters, thus enlarging letters d and f which were included in the previous screen in error space 57 and have already been enlarged. Error space 57 in this new keyboard includes one letter only, thus helping the user to type the desired key “f” in the example, and thus application 10 will fill field 20 with the letter “f”, showing the success of the user.

Thus, in one aspect, the invention is directed to a computer-implemented method for facilitating adaptive typing using a dedicated application (such as typing application 10) in conjunction with DATD 100, may involve the following procedures:
Executing a dedicated typing application on the DATD, wherein the application is specifically configured to adapt to and support varied user needs for assistive typing;
Analyzing user input patterns on a touch-sensitive display of the DATD, including mis-presses and typing behaviors, to identify individual user typing challenges and preferences;
Dynamically adjusting a virtual keyboard layout displayed on the DATD, including key sizes and positions, in real-time based on the analyzed user input patterns;
Providing a multimodal feedback mechanism within the application, including visual, auditory, and haptic feedback, based on user interactions with the virtual keyboard to aid in typing accuracy and learning;
Storing and retrieving user-specific profiles and calibration data within the application to offer a personalized and consistent typing experience across different sessions;
Incorporating learning modules and tutorials within the application, designed to assist users in developing typing skills and familiarizing themselves with the DATD's features;
Managing connectivity options within the application to facilitate synchronization with external devices and networks, enhancing the device's functionality and accessibility; and
Continuously updating and refining the application's adaptive algorithms based on ongoing user interaction and feedback, ensuring the application evolves to meet the changing needs and improvements of its users.

According to an embodiment of the invention, the process may include a first screen (30B) includes a touch-screen-keyboard (14), characters (52) of keys (54) of the touch-screen-keyboard (14) being controllable by the application (10) for differentiating between the characters (52), wherein the character control of each of the keys (54) is a function of typing of a letter currently expected by the typing application (10).

The characters (52) of each of the keys (54) may include:
lettering presence or absence on each of the keys (54),
size of each of the keys (54); and/or
filling or not filling a typed field (20) upon pressing the keys (54).

The character (52) of each of the keys (54) is further of a function of a difficulty level determined by the application (10) according to level of prior typing of the user.

The character (52) of each of the keys (54) according to the function of the typing of the letter currently expected by the typing application (10) may include:
enlarging any of the keys (54) upon being pressed therearound (56); and/or
absenting lettering of keys (54) which are not to be typed; and/or
presenting lettering of keys (54) which are not to be typed for misleading the typing.

The enlarging of the keys (54) upon being pressed therearound (56) may be repeated thus including repetition of the enlarging.

The typing application (10) may further include:
given text (18A) being displayed by the first screen (30A) for being typed; and/or voice (18B) of the given text (18A) for being typed, wherein selection between the given text (18A) and the voice (18B) is a function of a difficulty level determined by the application (10) according to level of prior typing of the user.

The letter currently expected to be typed may be accented in the given text (18A).

The typing application (10) may further include a second screen (30B) including a plurality items, each for offering different watching to a user, wherein selection of any of the items by the user displays the first screen (30A), and wherein the typing awards the user with the watching.

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

1. A device for language training, comprising:
a) a display; and
b) a processor adapted to operate the display according to a preselected difficulty level, wherein operating the display includes generating a virtual keyboard or a portion thereof, and simultaneously displaying a visual cue related to one or more word(s);
wherein one or more keys of the virtual keyboard are simultaneously activatable to display alphabet letters and/or digits, and wherein at least one of said keys is activatable to display a letter related to the visual cue.

2. The device of claim 1, wherein the difficulty level is increasable by increasing the number of letters and/or digits activated on the keyboard keys, which are unrelated to the words that describe the visual cue.

3. The device of claim 1, further comprising audio output element(s).

4. The device of claim 1, further comprising a logic electronic component adapted to determine:
i) when the correct letter in the sequence of letters of the word describing the visual cue has been selected by a user;
ii) which letter is the next in the sequence of letters of the word describing the visual cue to display; and
iii) when all letters in the sequence of letters of the word describing the visual cue have been correctly selected by a user.

5. The device of claim 1, comprising memory elements in which a plurality of visual cues are stored together with words related to them.

6. The device of claim 1, which is a dedicated assistive typing device (DATD) configured for enhancing typing experiences for users with varied needs, wherein the processer programmed to manage and execute software modules specifically designed for assistive typing, and wherein the display is a touch-sensitive display adapted to display a customizable and adaptive virtual keyboard layout, sensitive to individual user typing patterns and needs.

7. The device of claim 6, further comprising:
a calibration module for detecting user mis-press patterns and dynamically adjusting virtual key sizes and positions based on these patterns;
a user-specific adaptability module, enabled by the processing unit, to continually learn and recalibrate key sensitivity and boundaries over time based on individual user interactions and historical data;
an adaptive feedback system, managed by the processing unit, providing real-time multimodal feedback (visual, auditory, and/or haptic) based on user interaction to assist in typing accuracy and learning; and
one or more communication interfaces for wired and wireless connectivity, specifically tailored to support assistive devices and applications.

8. The device of claim 1, further comprising an ergonomic casing designed to accommodate various hand sizes and grips, enhancing user comfort and device usability, especially for users with physical disabilities or limitations.

9. The device of claim 7, wherein the adaptive feedback system includes a haptic feedback mechanism, providing tactile responses upon user interaction with the virtual keyboard, thereby aiding users with visual impairments or those requiring physical confirmation of key presses.

10. The device of claim 1, further comprising an integrated speaker and microphone, enabling voice-to-text functionality and auditory feedback, thereby facilitating use by users with visual impairments or fine motor skill challenges.

11. The device of claim 7, wherein the calibration module includes a touch point analysis feature that specifically identifies the most common areas around keys where mis-presses occur, allowing for precise and user-specific calibration.

12. The device of claim 1, wherein the user-specific adaptability feature includes a user feedback loop, enabling users to actively participate in the calibration process by providing feedback on key sensitivity and positioning.

13. A method for language training, comprising:
a) providing a display;
b) providing a processor adapted to operate the display according to a preselected difficulty level;
c) operating the display to generate a virtual keyboard or a portion thereof, and simultaneously displaying a visual cue related to one or more word(s);
wherein one or more keys of the keyboard are simultaneously activated to display alphabet letters and/or digits, and wherein at least one of said keys is activated to display a letter related to the virtual cue.

14. The method of claim 13, further comprising:
detecting individual user typing patterns and mis-presses via a touch-sensitive display surface;
dynamically adjusting virtual key sizes and positions on the display surface based on the detected typing patterns and mis-presses;
providing real-time adaptive feedback to the user through visual, auditory, or haptic means based on the user's interaction with the virtual keyboard; and
continuously learning and recalibrating key sensitivity and boundaries over time using user interaction data and historical data.

15. The method of claim 14, wherein detecting individual user typing patterns includes analyzing touch points and pressure sensitivity to identify common areas of mis-presses and the user's unique typing style.

16. The method of claim 14, including adjusting the haptic feedback mechanism to provide tactile responses tailored to the user's interaction and feedback, enhancing the typing experience for users with sensory impairments.

17. The method of claim 14, wherein providing real-time adaptive feedback includes utilizing an integrated speaker and microphone for auditory feedback and voice-to-text functionality, aiding users with visual impairments or fine motor skill challenges.

18. The method of claim 14, wherein the step of providing adaptive feedback is customized based on user-selected preferences, enabling a personalized interaction experience that caters to the specific needs and abilities of the user.

19. The method of claim 13, further comprising facilitating adaptive typing in a language learning context, using a dedicated application (App) in conjunction with a Dedicated Assistive Typing Device (DATD), comprising:
a) displaying an item on the DATD's screen, wherein the user views and selects an item of interest;
b) highlighting, by the App, the first or subsequent letter of the selected item's name, thereby guiding the user's focus to a specific part of the word;
c) generating a virtual keyboard on the DATD's display, where the key corresponding to the highlighted letter is visibly marked with the letter, and other keys are presented in a blank state, displaying only their outlines without letters or digits;
d) recording, by the App, the exact location of the user's press on the virtual keyboard, thereby capturing the user's interaction with the designated key;
e) evaluating, by the App, the correctness of the user's key press, determining whether the user successfully selected the key corresponding to the highlighted letter;
f) proceeding to the next instructional step if the correct key is pressed, which includes checking if the pressed key is the last letter in the item's name and, if so, activating the associated item, such as launching a multimedia content;
g) implementing an adaptive response if the correct key is not pressed, wherein the App assesses the frequency of incorrect key presses and, if exceeding a predetermined threshold (n times), modifies the virtual keyboard display by enlarging several keys based on the user's error range or mis-press pattern; and
h) prompting the user to press the enlarged key corresponding to the highlighted letter, thereby facilitating adaptive learning and improving user interaction with the DATD.
